(19) United States
(12) Patent Application Publication
(10) Pub. No.: US 2016/0110359 A1
(43) Pub. Date: Apr. 21, 2016

(54) Method and Apparatus for Logging Data Records

(71) Applicants: KEYSIGHT TECHNOLOGIES SINGAPORE (HOLDINGS) PTE. LTD., Singapore (SG); KEYSIGHT TECHNOLOGIES UK LTD, Berkshire (GB); KEYSIGHT TECHNOLOGIES UK LTD, Berkshire (GB)

(72) Inventor: Martin James Underwood, Farnborough, Hampshire (GB)

(21) Appl. No.: 14/894,066

(22) PCT Filed: May 27, 2014
(86) PCT No.: PCT/GB2014/051611

§ 371 Date: Nov. 25, 2015

(30) Foreign Application Priority Data
May 30, 2013 (GB) 1309656.5

(51) Int. Cl. G06F 17/30; G06F 11/14

(52) U.S. Cl. CPC G06F 17/3051; G06F 17/30368; G06F 11/1451

(57) ABSTRACT

A method and apparatus for logging data records on data received from a log source in a network comprising a plurality of log sources, the apparatus comprising a processor to format the received data into a log file data format encoded with a unique record identifier encoded in the log file data format for identifying and associating between data of records of a first record originating from first protocol data unit layer, and a second record originating from a second protocol data unit layer different from the first protocol data unit layer.

### TECHNICAL FIELD

This invention relates to a method and apparatus for logging data records, and more specifically, to a method and apparatus for logging data records from multiple log sources concurrently in networks, such as in mobile communication network simulation test systems.

### BACKGROUND

There are a variety of different radio communication protocols and standards currently in use. It is expected that more radio communication protocols and standards will be developed in the future. In the field of mobile communications, the communications protocols and standards include, for example, Global System for Mobile Communications (GSM) (2G), 3rd Generation Partnership Project (3GPP) (3G), Long Term Evolution (LTE), and LTE Advanced (4G).

User equipment (UE), such as mobile phones, smartphones, and the like, forming part of a communications network have radio transceivers that are required to switch between different mobile communications protocols and standards. Often UE developers and mobile network operators run mobile communication network simulation tests on the UE for development testing, conformance testing, and interoperability testing. Logging and analyzing the test data within such mobile communication network simulation test systems is increasingly complex as there are multiple types of logging records received from multiple sources concurrently with data rates of above 1.2 Gb/second.

There is a need for a method and apparatus for logging data records in networks such as in mobile communications network simulation test systems that address or at least alleviates the above issues.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the invention is an apparatus for logging data received from a log source in a network comprising at least one log source having a protocol data unit layer, the apparatus comprising a processor to format the received data into a log file data format encoded with a unique record identifier for identifying and associating between data of records of a first record originating from first protocol data unit layer, and a second record originating from a second protocol data unit layer different from the first protocol data unit layer.

In an embodiment the first protocol data unit layer may be a physical layer of open systems interconnection (OSI) protocols. The second protocol data unit layer may be a data link layer of open systems interconnection (OSI) protocols. The received data may be downlink data wherein the data passes from the second protocol data unit layer to the first protocol data unit layer. The received data may be uplink data wherein the data passes from the first protocol data unit layer to the second protocol data unit layer. The first record of data may be radio link control (RLC) data. The second record of data may be media access control (MAC) data.

In an embodiment the second protocol data unit layer may be network layer of open systems interconnection (OSI) protocols.

In an embodiment the first record and second record may be received from different log sources. The multiple source protocol data unit layer records may be transported via the first protocol data unit layer or second protocol data unit layer.

In an embodiment each record may comprise a header comprising the unique record identifier and a time identifier for identifying the time the data is logged at the log source and for identification of the log source from where data originates. The unique record identifier may comprise a counter that is incremented with each record originating from a log source. The log file data format may comprise a portion of data that is compressed.

In an embodiment the apparatus may comprise an encoder to encode the data with a time identifier for identifying the time the data is logged at the log source, and a log source identifier for identification of the log source from where data is received.

In an embodiment the processor may be arranged to reformat a first log file data format into a second log file data format. The processor may be arranged to reformat the log file data format into a log file view data format for output. The processor may be arranged to format the log file view data format into a filtered format without the first record of data relating to a first protocol data unit layer. The processor may format the log file data format into the log file view data format for output upon receipt of a request for output of the logging data. The processor may be arranged to load a partial set of the log file view data as required for output. The partially loaded log file view data may be cached in a memory and the processor may be arranged to load unloaded log file view data as required for output. The processor may be arranged to remove from memory the log file view data cached in memory after a predetermined time.

In an embodiment the network of log sources may be a mobile communications network simulation test system for running a test activity on user equipment. The first record of data and second record of data may be batched and stored according to the log source identifier. The log file data format may be arranged with at least two types of record data, a first type of log data relating to control records of a mobile communications network simulation test system, and a second type of log data relating to data records of a test of a user equipment. The log file data format may comprise a header wherein the header being uncompressed. The log file data format may comprise a data and control records section with data records and control records mixed in any order. The log file data format may be batched according to a trigger event. The trigger event may be based on a predetermined time.

An aspect of the invention is a logging server for logging data received from a log source in a network comprising at least one log source having a protocol data unit layer, the logging server comprising a processor for receiving and processing log file data formatted into a log file data format encoded with a unique record identifier for identifying and associating between data of records of a first record originating from first protocol data unit layer, and a second record originating from a second protocol data unit layer different from the first protocol data unit layer.

In an embodiment the logging server may further comprise a decoder for decoding the log file data formatted into a log file data format encoded with a unique record identifier for identifying and associating between data of records of a first record originating from first protocol data unit layer. The log file data may be stored into log files. The log file data format may comprise a time identifier for identifying the time the data was logged at the log source, and a log source identifier for identification of the log source from where data is received. The processor may be arranged to reformat the received data in a first log file data format into a second log file data format. The processor may be arranged to reformat the received data in a log file data format into a log file view data format for output. The processor may be arranged to format the log file view data format into a filtered format without the first record of data relating to a first protocol data unit layer. The processor may format the log file data format into the log file view data format for output upon receipt of a request for output of the logging data. The processor may be arranged to load a partial set of the log file view data as required for output.

In an embodiment the logging server may further comprise a memory wherein the partially loaded log file view data is cached in the memory and the processor is arranged to load unloaded log file view data as required for output. The processor may be arranged to remove from memory the log file view data cached in memory after a predetermined time.

In an embodiment the network of log sources is a mobile communications network simulation test system for running a test activity on user equipment. The first record of data and second record of data may be batched and stored according to the log source identifier.

In an embodiment the log file data format may be arranged with at least two types of record data, a first type of log data relating to control records of a mobile communications network simulation test system, and a second type of log data relating to data records of a test of a user equipment. The log file data format may comprise a header wherein the header being uncompressed. The log file data format may comprise a data and control records section with data records and control records mixed in any order. The log file data format may be batched according to a trigger event. The trigger event may be based on a predetermined time.

An aspect of the invention is a method of formatting log data received from a log source in a network comprising at least one log source having a protocol data unit layer, the method comprising receiving the log data from a log source; and formatting the received log data into a log file format with a unique record identifier encoded in the log file data format for identifying and associating between data of records of a first record originating from first protocol data unit layer, and a second record originating from a second protocol data unit layer different from the first protocol data unit layer.

In an embodiment the first protocol data unit layer may be a physical layer of open systems interconnection (OSI) protocols. The second protocol data unit layer may be a data link layer of open systems interconnection (OSI) protocols. The method may further comprise receiving the data as downlink data wherein the data passes from the second protocol data unit layer to the first protocol data unit layer. The data may be received as uplink data wherein the data passes from the first protocol data unit layer to the second protocol data unit layer. In an embodiment the first record of data may be radio link control (RLC) data. The second record of data may be media access control (MAC) data. The second protocol data unit layer may be a network layer of open systems interconnection (OSI) protocols. The first record and second record may be received from different log sources. The multiple source protocol data unit layer records may be transported via the first protocol data unit layer or second protocol data unit layer.

In an embodiment each record may comprise a header comprising the unique record identifier and a time identifier for identifying the time the data is logged at the log source and for identification of the log source from where data originates. The unique record identifier may comprise a counter that is incremented with each record originating from a log source. The log file data format may comprise a portion of data that is compressed. The data may be encoded with a time identifier for identifying the time the data is logged at the log source, and a log source identifier for identification of the log source from where data is received. A first log file data format may be reformatted into a second log file data format. The log file data format may be formatted into a log file view data format for output. The log file view data format may be formatted into a filtered format without the first record of data relating to a first protocol data unit layer. The log file data format may be formatted into the log file view data format for output upon receipt of a request for output of the logging data. The log file view data may be loaded as a partial set of the log file view data as required for output. The partially loaded log file view data may be cached in a memory, and loading unloaded log file view data as required for output. The log file view data cached in memory may be removed from the memory after a predetermined time.

In an embodiment the network of log sources is a mobile communications network simulation test system for running a test activity on user equipment. The first record of data and second record of data may be batched and stored according to the log source identifier. The log file data format may be arranged with at least two types of record data, a first type of log data relating to control records of a mobile communications network simulation test system, and a second type of log data relating to data records of a test of a user equipment. The log file data format may comprise a header wherein the header being uncompressed. The log file data format may comprise a data and control records section with data records and control records mixed in any order. The log file data format may be batched according to a trigger event. The trigger event may be based on a predetermined time.

An aspect of the invention is a log file data format for logging data received from a log source in a network comprising at least one log source having a protocol data unit layer, the log file data format comprising a unique record identifier encoded in the log file data format for identifying and associating between data of records of a first record originating from first protocol data unit layer, and a second record originating from a second protocol data unit layer different from the first protocol data unit layer.

In an embodiment the first record and second record are received from different log sources. Multiple source protocol data unit layer records may be transported via the first protocol data unit layer or second protocol data unit layer. Each record may comprise a header comprising the unique record identifier and a time identifier for identifying the time the data is logged at the log source and for identification of the log source from where data originates. The unique record identifier may comprise a counter that is incremented with each record originating from a log source. The log file data format may comprise a portion of data that is compressed. The log file data format may be formatted into a log file view data format for output. The log file data format may be arranged with at least two types of record data, a first type of log data relating to control records of a mobile communications network simulation test system, and a second type of log data relating to data records of a test of a user equipment. The log file data format may comprise a header wherein the header being uncompressed. The log file data format may comprise a data and control records section with data records and control records mixed in any order.

An aspect of the invention is a computer readable storage medium having stored therein instructions, which when executed by a device with a screen display, cause the device to display logging data received from a log source in a network comprising at least one log source having a protocol data unit layer, the device sends a request to an apparatus to format the logging data into a log file view data format for displaying on the screen display, the apparatus formatting the log file view data format from a log file format with a unique record identifier encoded in the log file data format for identifying and associating between data of records of a first record originating from first protocol data unit layer, and a second record originating from a second protocol data unit layer different from the first protocol data unit layer.

In an embodiment the first record and second record may be received from different log sources. Multiple source protocol data unit layer records may be transported via the first protocol data unit layer or second protocol data unit layer. Each record may comprise a header comprising the unique record identifier and a time identifier for identifying the time the data is logged at the log source and for identification of the log source from where data originates. The unique record identifier may comprise a counter that is incremented with each record originating from a log source. The log file data format may comprise a portion of data that is compressed. The data may be encoded with a time identifier for identifying the time the data is logged at the log source, and a log source identifier for identification of the log source from where data is received. The first log file data format may be formatted or reformatted into a second log file data format. The log file data format may be formatted or reformatted into a log file view data format for output. The log file view data format may be formatted or reformatted into a filtered format without the first record of data relating to a first protocol data unit layer. The log file data format may be formatted into the log file view data format for output upon receipt of a request for output of the logging data. A partial set of the log file view data may be loaded as required for output. The log file view data may be partially loaded and cached in a memory, and loading unloaded log file view data as required for output. The log file view data cached in memory may be removed from memory after a predetermined time.

In an embodiment the network of log sources may be a mobile communications network simulation test system for running a test activity on user equipment. The first record of data and second record of data may be batched and stored according to the log source identifier.

The log file data format may be arranged with at least two types of record data, a first type of log data relating to control records of a mobile communications network simulation test system, and a second type of log data relating to data records of a test of a user equipment. The log file data format may comprise a header wherein the header being uncompressed. The log file data format may comprise a data and control records section with data records and control records mixed in any order. The log file data format may be batched according to a trigger event. The trigger event may be based on a predetermined time.

The features of each of the above aspects and/or embodiments may be combined as appropriate, as would be apparent to a skilled person, and may be combined with any of the aspects of the invention.

### BRIEF DESCRIPTION OF THE DRAWINGS

For better understanding of the invention and to show how the same may be carried into effect, reference will now be made, by way of example only, to the accompanying figures, in which:

FIG. 1 illustrates schematically an overview of a network simulation test system in which a logging tool in accordance with an embodiment may be implemented;

FIG. 2 illustrates schematically a block diagram of modules of the network simulation test system of FIG. 1 shown in more detail in which an apparatus for logging data in accordance with an embodiment may be implemented;

FIG. 3 illustrates schematically a block diagram of a logging server in accordance with an embodiment;

FIG. 4 illustrates schematically a block diagram of components of a test application in accordance with an embodiment;

FIG. 5 illustrates schematically a block diagram of logging server interconnected with test applications in accordance with an embodiment;

FIG. 6 illustrates schematically a block diagram of a time synchronizer interconnected with test applications in accordance with an embodiment;

FIG. 7 illustrates schematically a block diagram of a test sentinel interconnected with test applications in accordance with an embodiment;

FIG. 8 illustrates schematically a block diagram of a unique record identification (URID) identifying an association between protocol layers as the submitted record and the previously submitted record in accordance with an embodiment;

FIG. 9 illustrates schematically a block diagram of a conversion from a log file to a log file view format in accordance with an embodiment;

FIG. 10 illustrates schematically a diagram of a log file structure in accordance with an embodiment;

FIG. 11 illustrates schematically a diagram of a control record of the log file structure shown in FIG. 10 in accordance with an embodiment;

FIG. 12 illustrates schematically a diagram of a control record of the log file structure shown in FIG. 11 with extended sub-header structure in accordance with an embodiment;

FIG. 13 illustrates schematically a block diagram of a logging data handling and batching sequence in accordance with an embodiment;

FIG. 14 illustrates schematically a diagram of a logging server as a gateway between log files and a logging graphical user interface (GUI) module application for presenting log datain accordance with an embodiment; and

FIG. 15 is a sequence diagram showing data virtualization and data caching for loading log data in the graphical user interface (GUI) module in accordance with an embodiment.

### DETAILED DESCRIPTION

It will also be appreciated that although features from each of the embodiments may be identified by difference reference numerals in the figures and throughout the description, similar features including the properties and functionality attributed thereto, from one embodiment may be interchangeable with those of another embodiment.

References will now be made in detail to the embodiments, examples of which are illustrated in the accompanying figures. In the following detailed description, numerous specific details are set forth in order to provide a thorough understanding of the invention. However, it will be apparent to one of ordinary skill in the art that the invention may be practiced without these specific details.

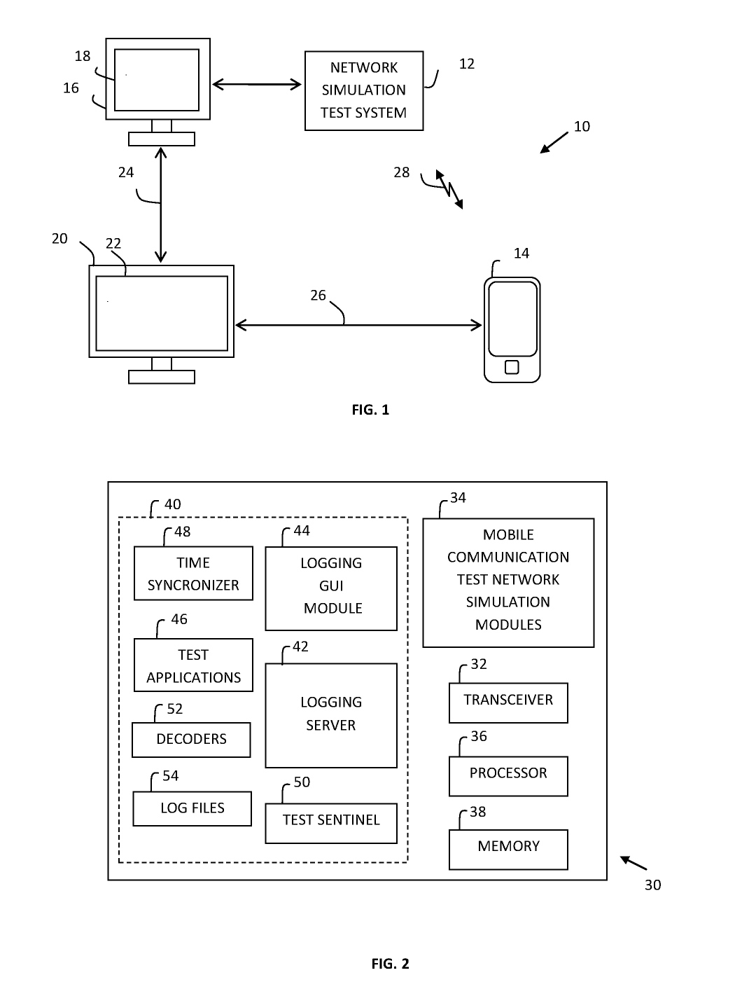

FIG. 1 illustrates schematically an overview of a network simulation test system in which a logging tool in accordance with an embodiment may be implemented. The overview system 10 comprises a network simulation test system 12 interconnectable with user equipment (UE) 14 and a test system computer or personal computer (PC) 16. UE 14 may be communication devices under test such as mobile phones, smartphones and the like, and may be arranged to switch between different mobile communications protocols and standards. The UE 14 as shown in FIG. 1 may be products under development in an unfinished state, such as, for example, UE software under development hosted on UE development hardware, for example, PC, ASIC or the like, and/or UE hardware under development, or the like.

The test system PC 16 in this example has a display 18 for displaying a graphical user interface (GUI) associated with the output of the network simulation test system 12 for management and control of the network simulation test system 12. A UE automation computer or PC 20 may be included in the system 12 with direct access via device control 26 to the UE 14 for controlling and automating the UE 14 during testing of the UE, such as power on/off, dialing a number and the like. The UE automation computer 20 may optionally have a display 22 for displaying a GUI associated with control and automation of the UE 14 while running the network simulation test system 12. Although a UE automation computer 20 is shown in FIG. 1, it will be appreciated that the UE 14 may be tested within the network simulation test system 12 in accordance with an embodiment without the UE automation computer 20.

The test system computer 16 in this example is connected with the network simulation test system 12. The test system computer 16 may be connected via remote control 24 to the UE automation computer 20 such as for controlling the UE man-machine interface (MMI) functions and other like functions of the UE 14. The network simulation test system 12 is connected via a communications wired or wireless link 28 such as radio frequency (RF) or the like to the UE 14 wherein the test system computer 16 and the network simulation test system 12 emulate a base station having different communications protocols and standards, such as, for example, Global System for Mobile Communications (GSM) (2G), 3rd Generation Partnership Project (3GPP) (3G), Long Term Evolution (LTE), LTE Advanced (4G) and the like according to the mobile communication network simulation modules of the system 12.

FIG. 2 illustrates schematically a block diagram of modules 30 of the system 10 of FIG. 1 shown in more detail in which an apparatus for logging data in accordance with an embodiment may be implemented. The network simulation test system 12 comprises a transceiver 32, mobile communication test network simulation modules 34, processor 36 and memory 38 which may reside in network simulation test system 12 of FIG. 1, and components of an apparatus for logging data within a system 10 in accordance with an embodiment shown within dashed box 40 which may reside in test system computer 16 of FIG. 1. The components of the apparatus for logging data within the network simulation test system 12 comprise a logging server 42, logging graphical user interface (GUI) module 44 including, for example, a protocol analyzer and the like, test applications 46, time synchronizer 48, test sentinel 50, decoders 52 and log files or database 54. The components of the network simulation test system 12 within dashed box 40 may be hosted in the test system computer 16. Additional instances of the time synchronizer 48 and logging client application programming interface (API) may be hosted alongside the mobile communication network simulation modules 34. The mobile communication test network simulation modules 34 communicates via a radio frequency (RF) transceiver 32 with the UE 14 via the test system computer 16 and the UE automation computer 20 with a connection such as a wired and/or wireless communication transmission means, such as RF connection, SAT(H), or the like, to emulate actual communication according to the multiple communications protocols and standards of each module which may include, for example, GSM (2G), 3GPP (3G), LTE, LTE Advanced (4G) and the like. It will be appreciated that the requirement of each module may be changed or altered in accordance with any required specification; for example, there may be any number of transceivers 32 or no transceivers such as in SAT(H) applications, or for example, there may be multiple processing devices each with associated central processing unit (CPU), memories and the like.

In the components of the apparatus for logging data within the network simulation test system, the logger or logging server 42 may be configured in different formats or platforms, such as a Singleton Windows service, or the like, and collates all log records received in the system from the multiple test applications 46 or from the mobile communication test network simulation modules, or the like, specifically each instance of the logging client application programming interface (API) discussed in further detail, and writes the log records to file. The logging server 42 reads log records from files as requested by the logging graphical user interface (GUI) module 44. The logging server 42 decodes log records from the log record data as received from the logging client API into a format that can be used and may be displayed on a display by the logging GUI module 44. The data received from the logging client API may be in a binary format, for example, that is suitable, e.g. a set of correctly formatted log records, for the logging server 42 to write directly to the log files 54. The logging server 42 presents decoded log records as requested to logging GUI module instances, and communicates control signals from the logging GUI instances to logging client API instances. The logging GUI module 44 component is used to present log records to the user in visual form, such as on display, or the like. The logging GUI module 44 may be multiple instances of the logging GUI module 44 hosted by different processes. The test applications 46 are shown and discussed in detail with respect to FIG. 4.

The time synchronizer 48 component is used to establish common, high precision time values on the test system computer 16, and on embedded test equipment. All log records are assigned time-stamps originating from an instance of the time synchronizer component 48.

The test sentinel 50 is a test system component that tracks the lifetime of test applications 46 and can notify clients when a test begins or ends. The logging system may use the test case sentinel notification such as, for example, to determine when a test application has closed unexpectedly and the associated test activity log file should be forcibly closed.

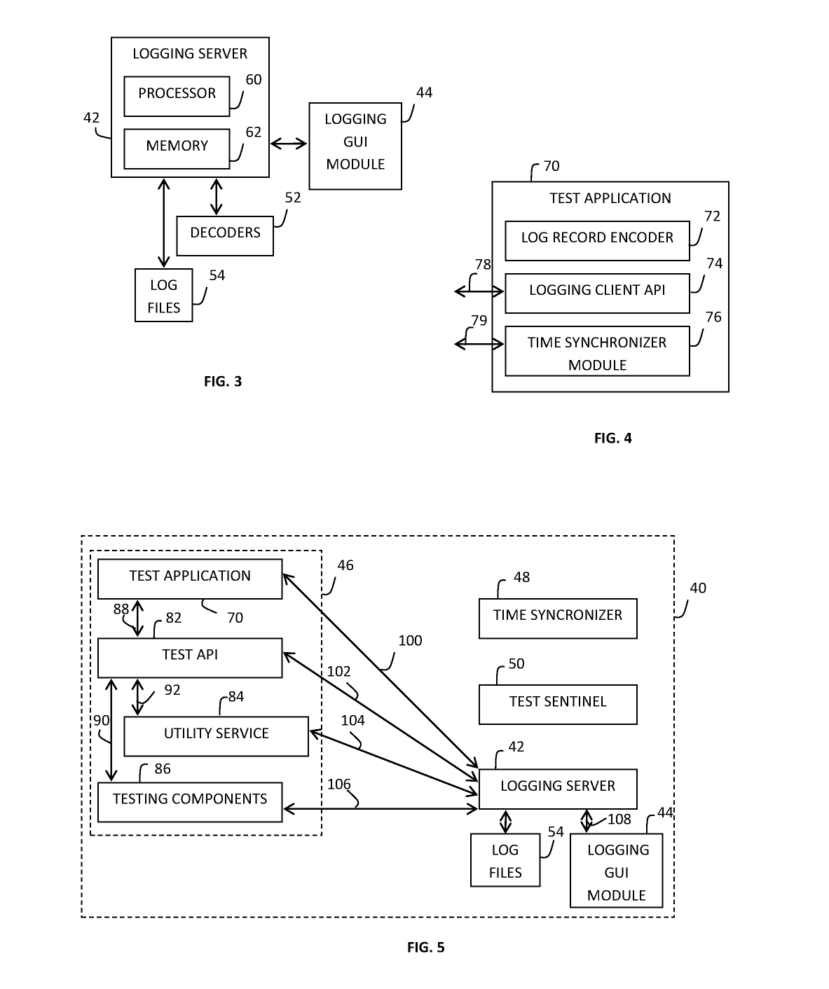

FIG. 3 illustrates schematically a block diagram of a logging server 42 in accordance with an embodiment. The logging server 42 comprises a processor 60 and a memory 62, and uses the log record decoders 52 and log files or database 54. It will be appreciated the logging server 42 may make use of other facilities that are not shown in FIG. 3 such as ethernet adapter, hard disk and the like. The log record decoders 52 may comprise multiple decoders, typically one decoder for each layer in each radio standard. The log record decoders 52 decode log records 54 as they are received at the logging server 42 into a form that can be understood by logging GUI instances. The log record decoders 52 may be implemented as Windows dynamic link library (DLL) with a C interface and are used by the logging server 42.

FIG. 4 illustrates schematically a block diagram of components of a test application in accordance with an embodiment. The test application 70 shows the basic components of log sources in the system. For example, the test application 70 comprises a log record encoder 72, logging client application programming interface (API) 74 and time synchronizer module 76. The log data including diagnostic system data and test activity data 78 is sent from logging client API to logging server 42, and receives time synchronization signal 79 from time synchronizer module 48. The log record encoders encode log record data into a form suitable for transportation to the logging server 42 and writing to file. The log record encoders 72 make direct use of a logging client API instance and may be compiled into the same image for use on the test system or embedded device such as other testing components. As with logging client API instances, the log record decoders 52 may be implemented as in-process COM server for use in the test system and as source code library for use on embedded devices. The logging client application programming interface (API) 74 is the API used by all logging clients. In an embodiment, the logging client API 74 is implemented as an in-process component object model (COM) server for use in the test system and as a source code library for use on embedded devices. It will be appreciated that the logging client may be implemented differently. The logging client API 74 implements several mechanisms including communication of log records to the logging server 42 from the client, communication of control signals from the logging server 42 to the client, and the like. It will be appreciated that there may be additional log sources in the system which are not shown.

FIG. 5 illustrates schematically a block diagram of logging server 42 interconnected with test applications 46 in accordance with an embodiment. The test application components include a test application 70, test application programming interface 82, utility service 84 and testing components 86, as examples of mobile communication test network simulation modules. API control signals are sent between 88 the test application 70 and the test API 82. API control signals are sent between testing components 86 and other embedded software and test API 90. API control signals are sent between 92 utility service 84 and test API 82.

Logging server interconnections are made between the logging sever 42 and the test application 70 via 100, test API 82 via 102, utility service 84 via 104, testing components 86 and other embedded software via 106, logging GUI module 44 via 108, and log files or database 54 via 109.

The test application 70 may be implemented by the system developer or a third party developer. The test application 70 may execute on the test system computer 46 and implement the specific test activity using one or more test API 82. Test applications may present log records directly to the logging system. The test API 82 implements various functions useful for implementing test applications including control of test equipment. Test API 82 typically implemented as in-process COM servers, or DLLs with a C interface. The test API 82, test application 70, utility service 84, testing components 86 and the like, may present log records to the logging system via log record encoders 72 and a logging client API instance. The utility service 84 implements a specific utility function and is typically used by test application 70 and/or test API 82. The testing components or other embedded software components may be installed and execute on the test system computer 16 or on other embedded devices and equipment, and may be hosted remotely (not shown). The testing components or embedded software components are controlled by the test APIs and generate log records that are sent to the logging system on the test system via a communication link such as for example ethernet, or the like.

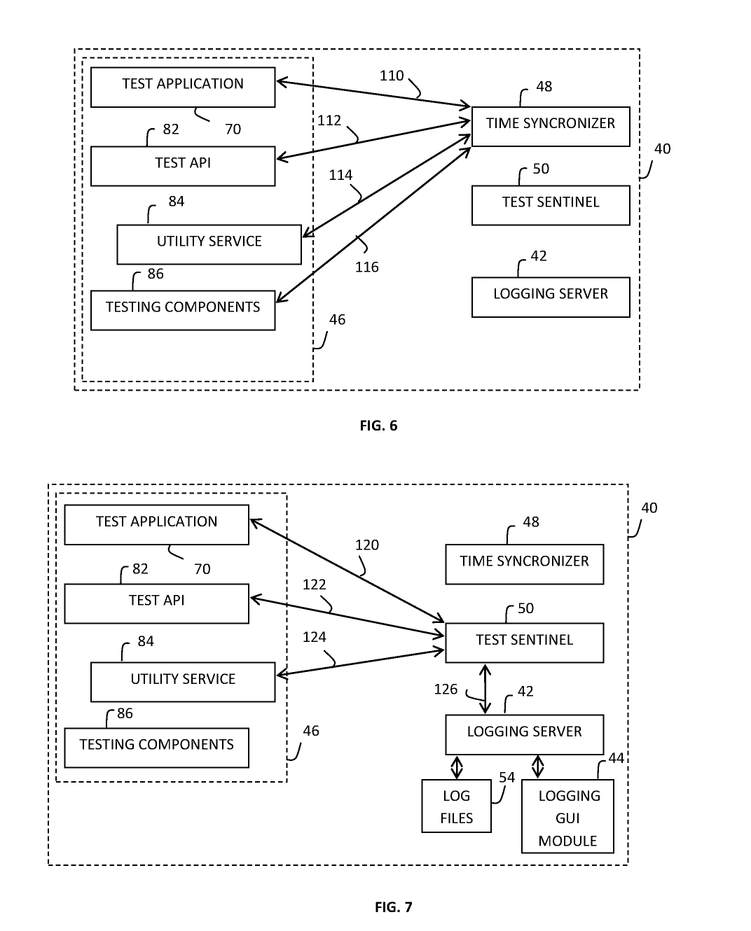

FIG. 6 illustrates schematically a block diagram of a time synchronizer 48 interconnected with test applications 46 in accordance with an embodiment. Time synchronizer 48 interconnections may be with test application 70 via 110, test API 82 via 112, utility service 84 via 114, and testing components 86 via 116 as depicted herein.

FIG. 7 illustrates schematically a block diagram of a test sentinel 50 interconnected with test applications 46 in accordance with an embodiment. Test sentinel 50 interconnections may be with test application 70 via 120, test API 82 via 122, utility service 84 via 124, and logging server 42 via 126 as depicted. Logging server 42 interconnections may be made between the logging server 42 and the logging GUI module 44 and the log files or database 54 as illustrated.

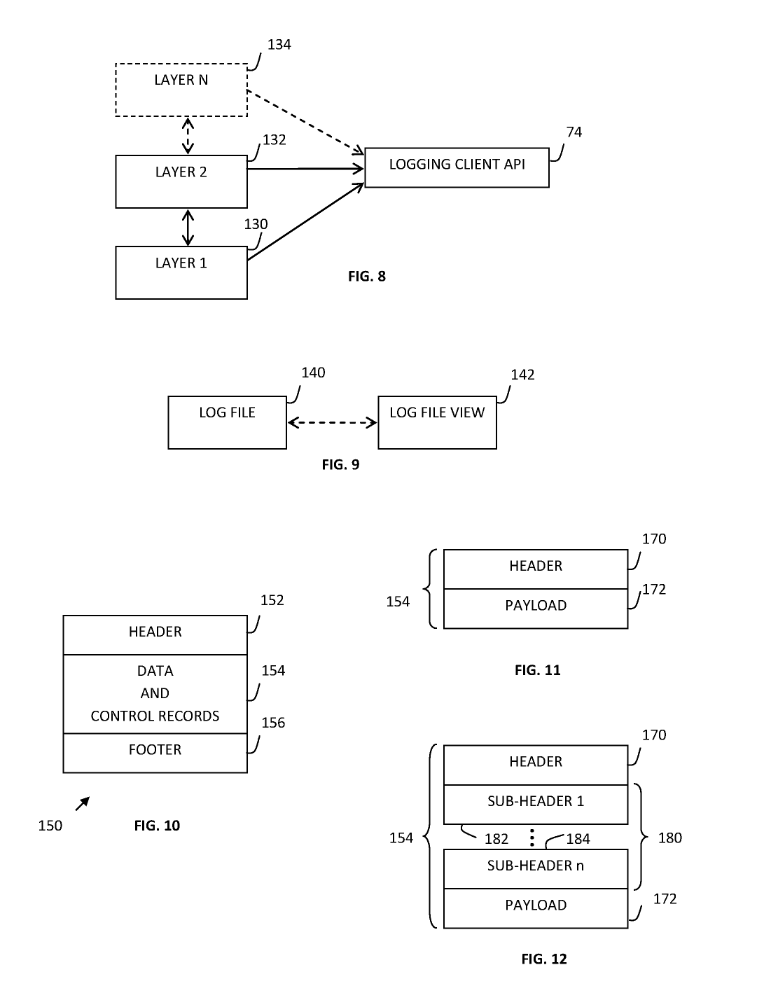

FIG. 8 illustrates schematically a block diagram of a unique record identifier (URID) identifying an association between protocol layers as the submitted record and the previously submitted record or a previously submitted record in accordance with an embodiment. The logging client API 74 receives the submitted records from layer 1 130 and layer 2 132 from a log source. In an embodiment, layer 1 may be the physical (PHY) layer, and layer 2 may be the radio link control (RLC) protocol and/or media access control (MAC) protocol 132 of the data link layer as defined in the open system interconnection (OSI) model standard protocols. An additional layer is shown as layer N data 134 in dashed box and dashed arrows above layer 2 indicating that one or more additional layers may be identified in addition to the two layers shown, and may differ from layer 1 and layer 2. It will be appreciated that other protocol layers may be identified as, for example, layer 3, layer 4, layer 5, layer 6, etc., and the like.

The enhanced logging system supports mechanisms to associate records with other records. This enables protocol data units (PDUs) to be associated with the abstract service primitive (ASP), acting as interfaces to transfer PDU between protocol layers, in which they are passed between layers in the mobile communication test network simulation modules 34, and for PDUs to be associated with PDUs from other layers and whose data they carry as payload. Whenever a record is submitted to the logging client API 74, a unique 64 bit identifier is returned constructed from at least two parts such as, for example, a 32 bit source ID identifying the log source, a 32 bit counter that is incremented with each record submitted to a logging client API instance, or the like.

When submitting subsequent records, this unique record ID (URID) may be used to identify an association between the record being submitted and the previously submitted record or a previously submitted record. It is anticipated that protocol layers may use this mechanism as illustrated in FIG. 8. For example, the RLC protocol entity 132 submits an RLC PDU to the logging system 74 and the logging system, e.g. logging client API 74, generates and assigns a URID to identify the PDU. The RLC protocol entity 132 submits the RLC PDU to its underlying MAC entity 130 for transmission to its peer. Alongside the PDU data, the URID is also supplied. MAC protocol entity 130 submits a MAC ASP to the logging system specifying the URID of the RLC PDU that it contains. It is given another URID to identify the logged ASP. MAC generates its own PDU and submits it to the logging system 74 specifying the URID of the RLC PDU that it contains. It is given another URID to identify the logged MAC PDU. For example, the MAC protocol entity 130 submits an MAC PDU to the logging system 74 together with the RLC PDU data and corresponding URID of the RLC PDU, and the logging system, e.g. logging client API 74, generates and assigns a URID to identify the MAC PDU.

It will be appreciated that in the above example, the RLC and MAC protocol entities may be located on the same host using the same logging client API instance, or located on different hosts using different logging client API instances. For uplink PDUs, a similar approach is taken but in reverse, i.e. lower layers supply URIDs of logged records to upper layers. Multiple associations may be identified (e.g. when multiple lower layer PDUs are generated to transport a single higher layer PDU). It will be appreciated that the associations may be by segmentation as described, concatenation, or the like. For concatenation, a multiple source PDU is transported via a single lower layer PDU. It will be appreciated that although logged PDUs can only identify their predecessors in log records, the logging server determines a PDU's successor by searching for records that identify it as a predecessor.

FIG. 9 illustrates schematically a block diagram of a conversion from a log file to a log file view format in accordance with an embodiment. The log file data format 140 and log file view data format 142 are shown. There are two main classes that can be used by client (reader) to handle log files, log file data format, and log file view data format. Log file data format is responsible for every single instance of real log file on disk. It shares methods that are common to all views that are bound with file. Log file view data format may represent instance of every view for current log file class and it may be created by its parent log file class. Views can have different filters that maintain how data should be shown to a user(s). All of them may depend and use raw data (records) from parent log file.

In an embodiment, the log server provides functionality that is related with file manipulation such as opening file, reading/writing records to file including filters, bookmarks, log data, and the like. After opening file for reading, data is started to be pre-processed. There are two structures that are created; a record type count which count how many times specific record appears in file, and a global, time-ordered record map which maps record index with position in file and header information of current record. This happens asynchronously with status reported to the reading client using a data update event. The client in order to show data may need to use log file view data format. This class provides functionality related with data (records which are in log file) as filtering and searching. Log file view data format creates its own “local data map” which mapped record index (after filtration) with its index from “global record map” from parent log file. Accordingly, the client is able to show different data from different log file view data format. It will be appreciated that the log files 140 viewing of the log files may be viewed during the runtime creation on the display 18 of the test system computer 16, or after the event and recalled on these computers 16,20 shown or separate computers, not shown, internal or external to the system.

FIG. 10 illustrates schematically a diagram of a log file structure format 150 in accordance with an embodiment. The log file 150 in this example comprises header 152, data and control records 154, and footer 156. The log file 150 may provide the possibility to use a compression algorithm to make the entire log much smaller, and further a way to use future extension with keeping backward compatibility. The log file structure of log may also enable faster searching and filtering of log records.

The log file may be built from records that may be divided into two groups of data including data records and control records. The data records are what an end user or user of the logging GUI module 44 is typically interested in, and the associated data corresponds as data records. The control records are what the server uses to manage log processing, and the associated data corresponds as control records. It will be appreciated that log files may be built, identified and separated into a single or any number of different records and series of logging records and information for different log files and databases for any required specification or specific application.

In an embodiment, the log file header 152 may contain information that is needed to get information from log file such as compression (type of compression that is used to compress headers), version (version of log file), date (creation date), unique identifier of computer (e.g. personal computer name), 64 bit value identifying offset to footer (see below) from the start of the file, number of records, and the like.

In an embodiment, headers 152 in the log file may not be compressed, so the header 152 is easily read without any knowledge of algorithm that is used to compress the rest of the log. The log file footer control information may be placed in footer 156 of log file 150 in a special record. The log file header 150 may contain a pointer to the beginning of the footer, and the footer 156 may be resizable. The control and data records 154 may be mixed in any order in the control and data records section of the file. The data that is saved after the log file 150 is created may be written to the footer 156 in one or more raw data control records.

FIG. 11 illustrates schematically a diagram of a data and control record 154 of the log file structure format 150 shown in FIG. 10 in accordance with an embodiment. The data and control record 154 shows header 170 and payload 172. Data log records have a common structure comprising header and payload. The header 170 stores information about the size of record, type of protocol, record and version in which it is encoded, and the like. Payload 172 stores record details (fields) and is decoded using specific decoders.

FIG. 12 illustrates schematically a diagram of a data and control record 154 of the log file structure shown in FIG. 11 with extended sub-header structure 180 in accordance with an embodiment. Data records types may have a common generic header 170 that contain information that is needed to decode rest of record data. The content of the record header 170 provides the means for top level filtering and sorting. The header 170 may be common for both data and control records 154 as defined in Table 1.

TABLE 1
Common record header fields

| Nr. | Field | Maximum Size(bit) |
|---|---|---|
| 1 | Record size | 32 |
| 2 | Protocol identifier | 16 |
| 3 | Protocol version | 16 |
| 4 | Record identifier | 32 |
| 5 | ClientID | 16 |
| 6 | Sequence Number | 32 |
| 7 | Local Logging SourceID | 16 |
| 8 | Time | 64 |
| 9 | Header extension flag | 8 |

In an example, the size of primary data header may be 27 B (without any compression methods). Header extension flag field is in header to give possibility of adding additional fields to some records and to allow flexibility in future use.

In an embodiment, the header extension flag allows possibility to have up to 255 extensions, and indicates how many extensions there are in current record. The header extension may be written as sub-header 182,184 which may have at first field, its type, and the next sets of fields that depend from what type it is.

In an embodiment, a special protocol may be created especially to contain information which is described by the control records. These records may store information that is useful to the logger server but they are not seen as log records by the client. Control records may contain information about number of records, type of compression, and the like.

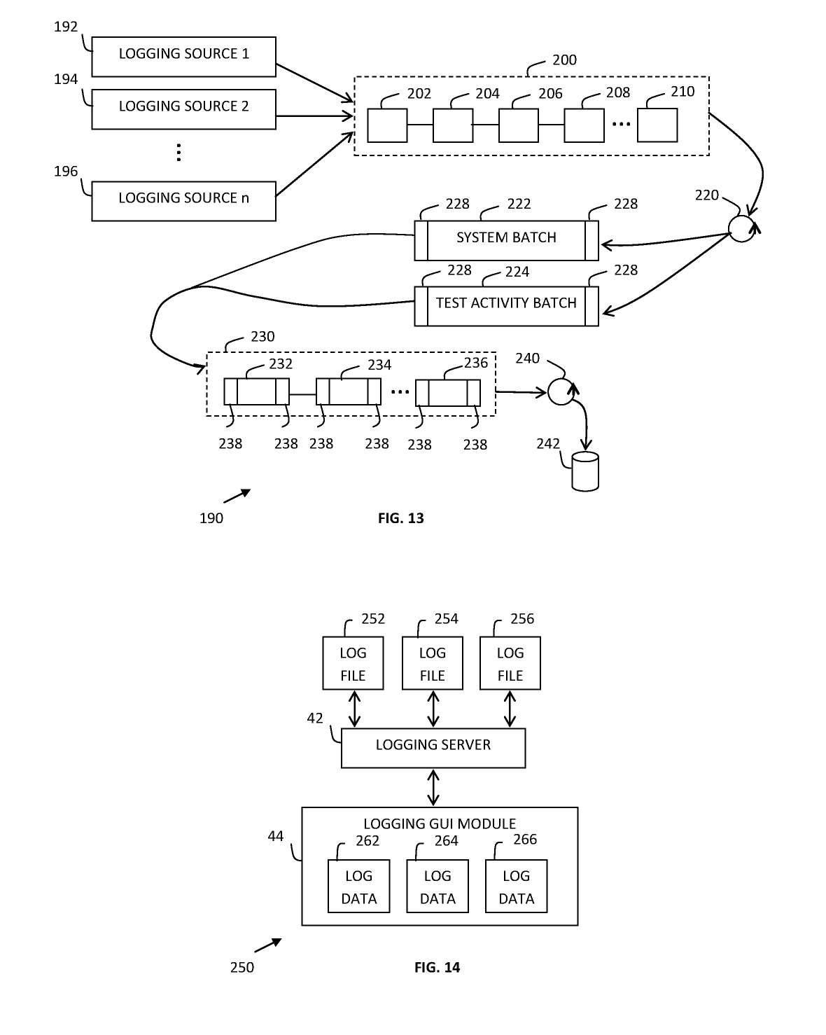

FIG. 13 illustrates schematically a block diagram of a logging data handling and batching sequence 190 in accordance with an embodiment. The logging data handling and batching sequence 190 is preferably performed in the network simulation test system 12, and then sent to the log server 42 via the logging client API 74 of each test application 70. The logging data handling and batching sequence 190 shows multiple logging sources 192,194,196 providing data in a delay queue 200. The delayed data 202,204,206,208,210 is taken in sequence and a control record 228 is added 220 acknowledging start of the test activity. Control records are added by the logging client API 74 to the transmission queue 230 in sequence with data records submitted by the logging sources. The control record identifies the data as system batch 222 type data, or test activity batch 224 type data. The system batch 222 type data and the test activity batch 224 type data is held in a transmission queue 230 as delayed data with control record 238 batched data 232,234,236. The control record is removed 240 from the transmit queue 230 before being sent to the socket 242 to logging server 42. It will be appreciated that in an embodiment the control record is sent over ethernet via logger server interconnections 106 to the logging server 42 to the file.

In an embodiment, an activity of the logging client API 74 is to collate logging data submitted by the logging sources it serves and to transport it to the logging server 42 where it can be written to file. This activity may be split into three sub-tasks of delaying the data for a fixed period, collating the data and constructing the log records, and transporting prepared log records to the log server 42.

In an embodiment, a logging source is any entity in the system that generates logging data. Each logging source is preferably registered with one logging client API instance before the logging source submits logging data. When logging data is first submitted, it is time-stamped and placed directly in a time delay queue 200. This operation occurs in the context of the calling client's thread. It is then emptied by a dedicated thread within the logging client API 74 that then determines whether each record should be captured according to the current logging settings or not, constructs a series batch records containing only the records that must be captured according to the current logging settings, and places the formatted batch records into a transmission queue 230 for transfer to the logging server 42.

The time delay queue 200 is to delay the transit of logging records to the logging server 42. The time delay queue 200 serves to overcome delays in the notifications that can change the current logging settings assuming that the delays are not greater than the time a record is required to wait in the time delay queue 200. The time delay queue 200 may delay the transit of records by a period of time such as, for example, 250 ms. It will be appreciated that any period of time may be specified.

In an embodiment, other log setting rules may be implemented to adjust the logging settings. For example, event triggered logging may be defined and set for different specific applications, such as a time delayed log setting criteria, a protocol defined log setting criteria, and the like.

In an embodiment, different series of logging records may be batched separately for storage in different log files/databases. For example, logging records may be identified as different logging types depending on the type of logging source, type of data associated with the logging source, or the like, generated from the different originating logging sources and batched accordingly. In an example, logging sources are identified as a first type of logging source that generates data associated with system or control records, and a second type of logging sources that generates data associated with test activity or data records. For example, log records that do not relate to test system activity may be identified as system log control records that may be relevant to the management of the system generally. Such system log data and control data may be identified separate to test activity log data and test activity data. In this example, log records generated by system logging sources are not batched with those from test activity logging sources since they may be destined for separate log files. Each stream is logged with a separate logging client ID which allows the logging server 42 to assume that the log records submitted with an individual logging client ID are all in time-order. Batch records are submitted to the transmit or transmission queue 230, for example, when the size limit configurable at compile time would be exceeded if another record was added, or when a transmission timer expires, or the like. For example, there may be no batch record from the logging stream in the transmit queue 230 and a connection is established with a logging server 42 instance and the first record in the batch is older, for example, 1 second, than the last. It will be appreciated the above example is for illustrative purpose and that logging records may be identified and batched according to different series of logging records and criteria, and in any number of series of logging records as described by example herewith.

In addition, the batch record being constructed by test activity logging sources 224 may be submitted to the transmit queue 230 immediately when the logging client API 74 is notified that a test activity log file is being created or closed.

The transmission queue 230 may be serviced by another thread that is internal to the logging client API 74. This thread waits for establishment of a connection to a logging server 42 instance and, pending data to arrive in the transmission queue 230. When both these conditions are fulfilled, the thread may remove items from the front of the queue and may send them to the logging server 42.

When the logging client API 74 is notified that a test activity log file is being created, it submits a control record to the time delay queue 200. When this control record 228 is reached in the time delay queue, the current batch record being constructed by the test activity logging stream is submitted to the transmission queue 230. A control record 238 is also added to the transmit queue acknowledging the start of the test activity. When the control record is removed from the transmission queue the logging client API sends a message to the logging server 42 acknowledging the start of the test activity.

When a logging client API 74 is notified that a test activity log file is being closed, the logging client API 74 submits a control record 220 to the time delay queue 200. When this control record 220 is reached in the time delay queue 200, the current batch record being constructed by the test activity logging stream is submitted to the transmission queue 230. A control record 238 is also added 240 to the transmission queue 230 acknowledging the end of the test activity. When the control record 220 is removed from the transmission queue 230 the logging client API 74 sends a message to the logging server 42 acknowledging the closure of the test activity.

FIG. 14 illustrates schematically a diagram 250 of a logging server 42 as a gateway between log files 252,254,256 and a logging graphical user interface (GUI) module 44 application for presenting log data 262,264,266 in accordance with an embodiment. The log data 262,264,266 may be displayed in different formats such as in a GUI displayed on a computer screen such as display 18 of test system computer 16, or the like. The log data viewing of the log files may be viewed during the runtime creation on the display 18 of the test system computer 16, or after the event and recalled on these computers 16,20 shown or separate computers, not shown, internal or external to the system. In the GUI, a log file can be presented in an application in a set of different views and presented as log data in any number of different ways. Log views may be arranged in a pluggable control with sets of functionality used for displaying data contained in the log files in a specific view or format, such that opened log file application builds sets of log views from all the provided plug-in DLLs. For example, log data may be presented in different graphical forms and views such as a summary view with a summary of information for the log files, hierarchical connection between log record views, and the like. Additional features may be provided such as filtering, searching, bookmarking, facilities allowing the user to turn on/off views, and the like.

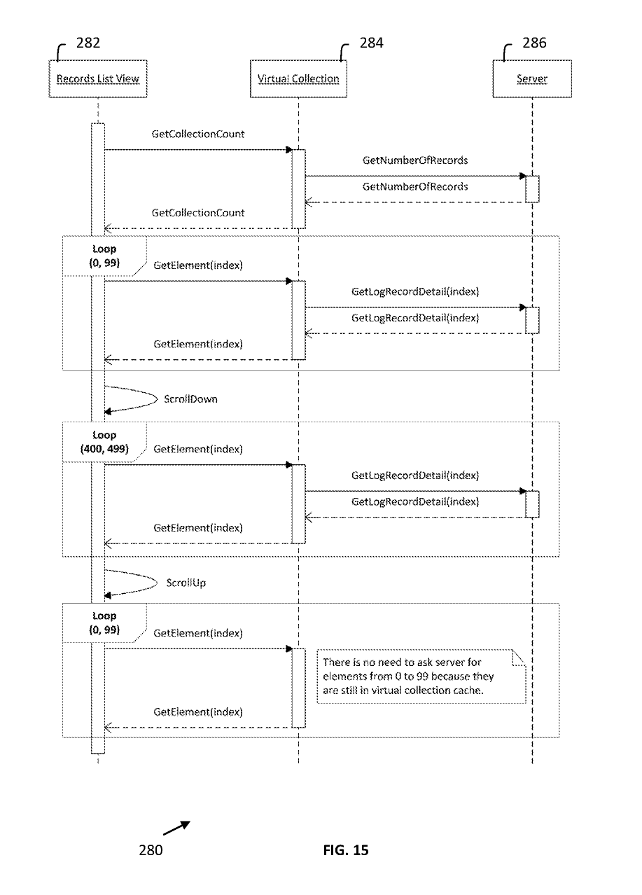

FIG. 15 is a sequence diagram 280 showing data virtualization and data caching for loading log data in the graphical user interface (GUI) module 44 in accordance with an embodiment. In an embodiment, data caching, data virtualization and GUI virtualization techniques may be implemented to limit the amount of data shown in a log data view in view of the size of log data with large number of data records. The sequence diagram 280 shows the process of data virtualization and data caching between the records list view 282, virtual collection 284, and the server 286. GUI virtualization is a process of displaying GUI elements in a way that only currently visible elements are created. GUI virtualization reduces used memory for displaying lists with large number of records, i.e., total set of records, when only a few records, i.e. partial set of records, are visible on the GUI at one time. Data virtualization is a data collection technique which loads only this part of the data, i.e. partial set of records, which is necessary for displaying or presenting. Virtual collection may be used to store the data on the client side. In essence, the virtual collection only loads those elements which are currently used. For example, when log data contains 1000 elements, only 100 elements may be loaded because the GUI is able to adequately display or present within the memory and processing capabilities of the GUI module within a predetermined limit, for example, only the 100 elements in this example. Elements that are no longer required or necessary for the current presentation via the GUI are removed from memory. Along with data virtualization, data caching is used so that elements in the virtual collection that are no longer needed or necessary for the current presentation are not removed immediately, but are stored for a specified period.

The systems and apparatus described above may be implemented at least in part in computer software. Those skilled in the art will appreciate that the apparatus described above may be implemented using general purpose computer equipment or using bespoke equipment. The different components of the systems may be provided by software modules executing on a computer.

The hardware elements, operating systems and programming languages of such computers are conventional in nature, and it is presumed that those skilled in the art are adequately familiar therewith. In an embodiment the server may be centrally located and the clients are distributed. In other embodiments, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1.-105. (canceled)

106. An apparatus for logging data received from a log source in a network comprising at least one log source having a protocol data unit layer, the apparatus comprising:
a processor configured to format the data received from the log source into a log file data format encoded with a unique record identifier for identifying and associating between data of records of a first record originating from a first protocol data unit layer, and a second record originating from a second protocol data unit layer different from the first protocol data unit layer.

107. The apparatus of claim 106, wherein the first protocol data unit layer is a physical layer of open systems interconnection (OSI) protocols.

108. The apparatus of claim 106, wherein the second protocol data unit layer is a data link layer of open systems interconnection (OSI) protocols.

109. The apparatus of claim 106, wherein the received data is downlink data wherein the data passes from the second protocol data unit layer to the first protocol data unit layer.

110. The apparatus of claim 106, wherein the received data is uplink data wherein the data passes from the first protocol data unit layer to the second protocol data unit layer.

111. The apparatus of claim 106, wherein the first record of data is radio link control (RLC) data.

112. The apparatus of claim 106, wherein the second record of data is media access control (MAC) data.

113. The apparatus of claim 106, wherein the second protocol data unit layer is a network layer of open systems interconnection (OSI) protocols.

114. The apparatus of claim 106, wherein the first record and second record are received from different log sources.

115. The apparatus of claim 106, wherein multiple source protocol data unit layer records are transported via the first protocol data unit layer or second protocol data unit layer.

116. The apparatus of claim 106, wherein each record comprises a header comprising the unique record identifier and a time identifier for identifying the time the data is logged at the log source and for identification of the log source from where data originates.

117. The apparatus of claim 106, wherein the unique record identifier comprises a counter that is incremented with each record originating from a log source.

118. The apparatus of claim 106, wherein the log file data format comprises a portion of data that is compressed.

119. The apparatus of claim 106, further comprising:
an encoder to encode the data with a time identifier for identifying the time the data is logged at the log source; and
a log source identifier for identification of the log source from where data is received.

120. The apparatus of claim 106, wherein the processor is arranged to reformat a first log file data format into a second log file data format.

121. The apparatus of claim 106, wherein the processor is arranged to reformat the log file data format into a log file view data format for output.

122. The apparatus of claim 106, wherein the processor is arranged to format the log file view data format into a filtered format without the first record of data relating to a first protocol data unit layer.

123. The apparatus of claim 106, wherein the processor is configured to format the log file data format into the log file view data format for output upon receipt of a request for output of the logging data.

124. The apparatus of claim 106, wherein the processor is arranged to load a partial set of the log file view data as required for output.

125. The apparatus of claim 106, wherein the partially loaded log file view data is cached in a memory and the processor is arranged to load unloaded log file view data as required for output.

126. The apparatus of claim 125, wherein the processor is arranged to remove from memory the log file view data cached in memory after a predetermined time.

127. The apparatus of claim 106, wherein the network of log sources is a mobile communications network simulation test system for running a test activity on user equipment.

128. The apparatus of claim 106, wherein the first record of data and second record of data are batched and stored according to the log source identifier.

129. The apparatus of claim 106, wherein the log file data format is arranged with at least two types of record data, a first type of log data relating to control records of a mobile communications network simulation test system, and a second type of log data relating to data records of a test of a user equipment.

130. The apparatus of claim 106, wherein the log file data format comprises a header wherein the header being uncompressed.

131. The apparatus of claim 106, wherein the log file data format comprises a data and control records section with data records and control records mixed in any order.

132. The apparatus of claim 106, wherein the log file data format is batched according to a trigger event.

133. The apparatus of claim 132, wherein the trigger event is based on a predetermined time.

134. The apparatus of claim 106, wherein the apparatus is a log server, configured to log data received from the log source having a protocol data unit layer.

135. A non-transitory computer readable medium comprising instructions, executable a processor of a device, which when executed by an apparatus for logging data received from a log source in a network device with a screen display, cause the apparatus to perform a method of formatting log data received from a log source in a network comprising at least one log source having a protocol data unit layer, the method comprising:
receiving the log data from a log source; and
formatting the received log data into a log file format with a unique record identifier encoded in the log file data format for identifying and associating between data of records of a first record originating from first protocol data unit layer, and a second record originating from a second protocol data unit layer different from the first protocol data unit layer.

136. The non-statutory computer readable medium of claim 135, wherein the first protocol data unit layer is a physical layer of open systems interconnection (OSI) protocols.

137. The non-statutory computer readable medium of claim 135, wherein the second protocol data unit layer is a data link layer of open systems interconnection (OSI) protocols.

138. The non-statutory computer readable medium of claim 135, wherein receiving the data as downlink data wherein the data passes from the second protocol data unit layer to the first protocol data unit layer.

139. The non-statutory computer readable medium of claim 135, wherein receiving the data as uplink data wherein the data passes from the first protocol data unit layer to the second protocol data unit layer.
